(19) United States
(12) Patent Application Publication
(10) Pub. No.: US 2009/0179015 A1
(43) Pub. Date: Jul. 16, 2009

(54) LASER ADJUSTABLE DEPTH MARK SYSTEM AND METHOD

(75) Inventors: Xiaodong Zhao, Beijing (CN); Yingjie Geng, Beijing (CN)

Correspondence Address: DLA PIPER LLP (US ), 2000 UNIVERSITY AVENUE, EAST PALO ALTO, CA, 94303-2248, US

(73) Assignees: AXT, INC., Fremont, CA (US); GSI Technology, Inc., Santa Clara, CA (US)

(21) Appl. No.: 12/014,695

(22) Filed: Jan. 15, 2008

(30) Foreign Application Priority Data
Jan. 14, 2008 (CN) 200810000675

(51) Int. Cl. B23K 26/00

(52) U.S. Cl. 219/121.68

(57) ABSTRACT

A system and method for adjustable laser mark depth is provided. In one embodiment, the system is used in Nd—YAG laser marker for wafer processing in the semiconductor industry, with smart control of the mark depth and expanded work range between the deep mark and the light mark.

### PRIORITY CLAIM/RELATED APPLICATIONS

This application claims priority under 35 USC 119 to Chinese Patent Application No. 200810000675.0, filed on Jan. 14, 2008, which is incorporated herein by reference.

### FIELD

The system and method relate to a laser marker and in particular to a laser marker used in wafer processing in the semiconductor industry.

### BACKGROUND

Currently, laser mark technology is widely used in many different industries and areas. The lasers used for marking include neodymium-doped yttrium aluminum garnet (Nd:Y₃Al₅O₁₂) lasers also known as Nd:YAG lasers or CO₂ lasers. Higher power excimer lasers are not used for marking due to the work conditions that affect the excimer laser and the high cost of the excimer laser. In laser marking, a high energy density laser beam irradiates a partially processed material surface, such as a semiconductor wafer surface, to produce a thermal excitation at the surface that causes fusion, burning or evaporation on or near the surface which results in a permanent mark being left on the material surface that then acts as an identification mark for the particular material surface.

The Nd:YAG and CO₂ lasers that are used broadly in the semiconductor industry have some limitations and drawbacks. These types of lasers cause thermal damage and thermal diffusion that blur the mark and cause a lot of splatter due to the local melting of the heated surface. The splatter effect can be clearly seen using an optical microscope under high magnification. Furthermore, new semiconductor technologies require new marking requirements that cannot be met with Nd:YAG and CO₂ lasers. The new requirements require a laser mark of a depth d<1 μm, diameter d) 30 μm without splatter. At present, only an excimer laser is able to meet these demands. Furthermore, it is particularly difficult to make a light mark on many soft semiconductor materials, such as gallium arsenide (GaAs) or indium phosphide (InP) for depth d<1 μm, without splatter.

In addition, due to different processing procedures and requirements, both a hard mark (with a depth of 5-100 μm) and/or a soft mark (depth: 3-5 μm) are needed. However, the currently available laser markers cannot produce both a hard mark and a soft mark that meet the requirements. This, in turn, leads to limited work range, high expenses and lower efficiency of the equipment. Thus, it is desirable to provide a laser adjustable depth marking system and method that overcomes the above limitations of typical systems and it is to this end that the present invention is directed.

### BRIEF DESCRIPTION OF THE DRAWINGS

FIG. 1 illustrates an example of an implementation of a laser marker system;

FIG. 2 illustrates a light path in the laser marker system;

FIG. 3 illustrates details of the adjustable polarizing device of the laser marker system;

FIG. 4 illustrates the laser marks made with different polarizer angles;

FIG. 5 illustrates a light mark created using the system shown in FIG. 1;

FIG. 6 illustrates an example of a soft mark; and

FIG. 7 illustrates an example of a hard mark.

### DETAILED DESCRIPTION OF ONE OR MORE EMBODIMENTS

The system and method are particularly applicable to Nd:YAG laser marker for wafer processing in the semiconductor industry and it is in this context that the system and method are described. It will be appreciated, however, that the system and method has greater utility since it can be implemented with other types of lasers or in various other industries.

The system and method provide adjustable laser mark depth, implemented in one embodiment with a Nd:YAG laser, that may be used for wafer processing in the semiconductor industry. The system provides smart control of the mark depth and expanded work range between the deep/hard mark and the light/soft mark. For example, the system produces a light mark with a depth of less than 1 μm and a diameter Φ≈30 μm, without splatter with close to the effect created by the more expensive excimer laser, but also a perfect soft mark and/or hard mark over 100 μm, can be processed on such semiconductor wafer as gallium arsenide (GaAs), indium phosphide (InP), silicon (Si), and/or germanium (Ge).

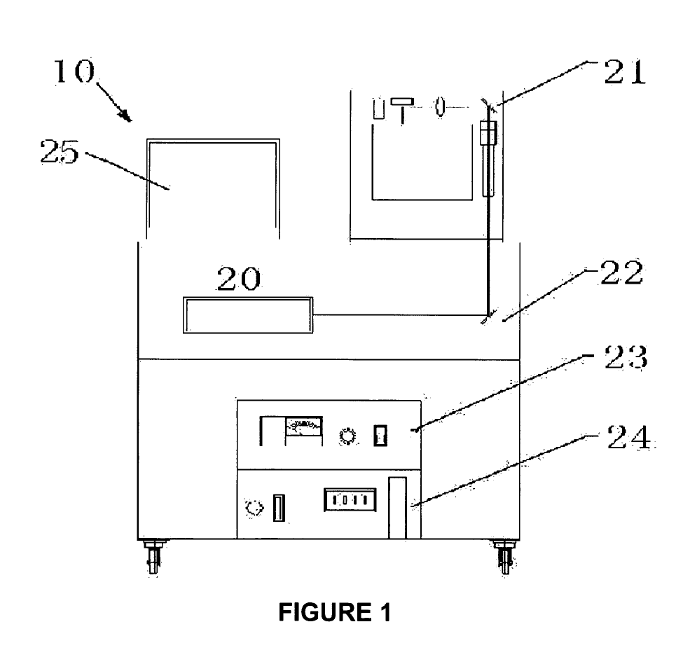

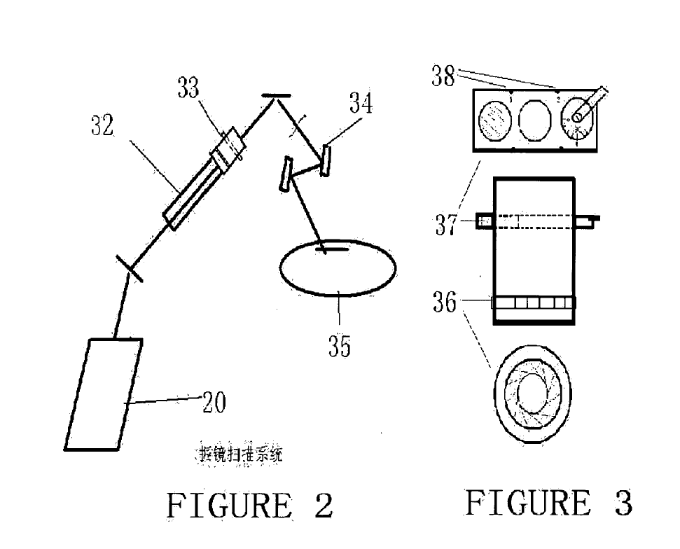

FIG. 1 illustrates an example of an implementation of a laser marker system 10 that uses a laser light generator 20, such as a Nd:YAG laser in this implementation and FIG. 2 illustrates a light path in the laser marker system 10. As shown in FIG. 1, the system 10 may include the laser 20, a galvanometric scanning system 21, a laser transmitting system 22, a laser power supply 23, a cooling system 24 and a computer control system 25. This system conforms to commercial laser marking systems that are presently used in the industry. As shown in FIG. 2, the light path of the system may include the laser light generator 20, a laser beam expander 32 that expands the light, an adjustable polarizing device 33 that adjusts the laser light polarization and a galvanometer 34 that directs the laser light towards a piece of material 35 (such as a substrate) to mark that piece of material. As shown in FIG. 3, the adjustable polarizing device 33 may further comprise an aperture device and a polarizer angle device 37. The laser light goes through the laser beam expander 32 and arrives at the aperture device 36 and the polarizer angle device 37. The aperture and polarizer angle can be adjusted, the scattered light can be filtered and the polarized angle of the laser light can be modulated so that the laser light energy density for marking the piece of material is more precisely controlled. The control occurs via the well known Malus Law as described in equation (1), where θ is the angle of polarization. From that equation, it is clear that at θ=0° the original laser light intensity I_{Original} will not be modified, whereas for θ=90° the output laser light intensity is completely blocked. At the appropriate θ value, the laser light energy will be just sufficient to melt the surface of the piece of material 35 (such as semiconductor substrate) without splatter. The laser marking system shown in FIG. 1-3, thus produces a light mark of depth d<1 μm, diameter d) 30 μm, without splatter using a laser other than an expensive excimer laser. The system may includes a device for physically changing the angle of polarization of the polarizer via a gear mechanism 38.

In more detail, the diameter, depth and splatter of each laser marking point are dependant on the laser energy and controlling the energy density of the laser light. The diaphragm controls the amount of laser light that passes onto the galvanometer 34 and onto the piece of material 35 the polarizer angle device 37 controls the polarization of the laser light. If the angle between the polarizing direction of light and that of polarized light module changes, in terms of formula:

I=(I_{Original})×Cos²θ (1)

then the system can generate laser light of appropriate energy between I_{Original} and 0 that can be directed to the surface of the piece of material.

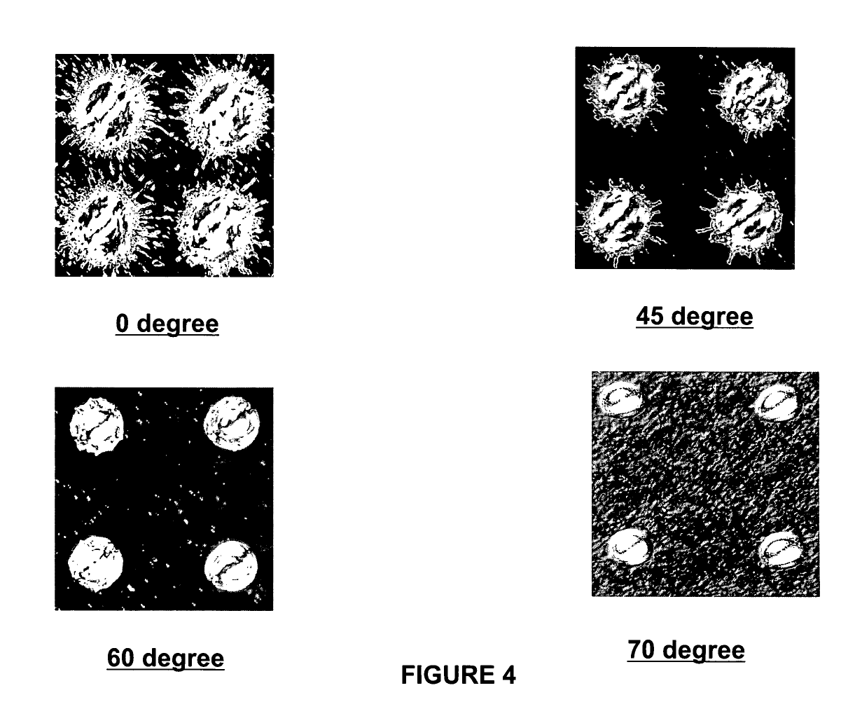

The following Table 1 and FIG. 4 illustrate the effect of changing the polarizer angle θ on the extent of the laser mark and associated splatter.

TABLE 1

| Polarizer angle (°) | Laser power (W) | Frequency (Hz) |
|---|---|---|
| 0 | 0.56 | 9000 |
| 45 | 0.32 | 9000 |
| 60 | 0.24 | 9000 |
| 70 | 0.12 | 9000 |
| 90 | 0.04 | 9000 |

FIG. 4 illustrates the laser marks made with different polarizer angles of 0 degrees, 45 degrees, 60 degrees and 70 degrees. By controlling the laser energy density of the laser light that strikes the surface, a mark with depth d<1 μm, diameter Φ≈30 μm, high definition and without splatter can be obtained. The laser marking system expands the work range of the laser marker and provides accurate control on mark depth for high standard, depth d<1 μm, diameter Φ≈30 μm without splatter marks as well as normal soft or hard mark processing requirements (depth=3 μm-100 μm).

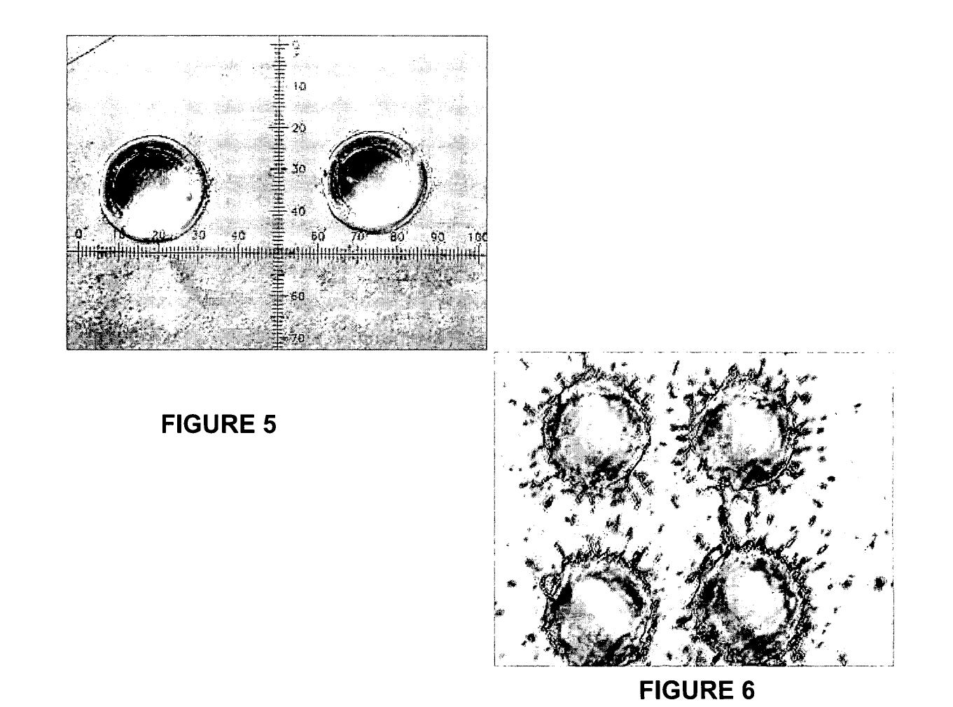

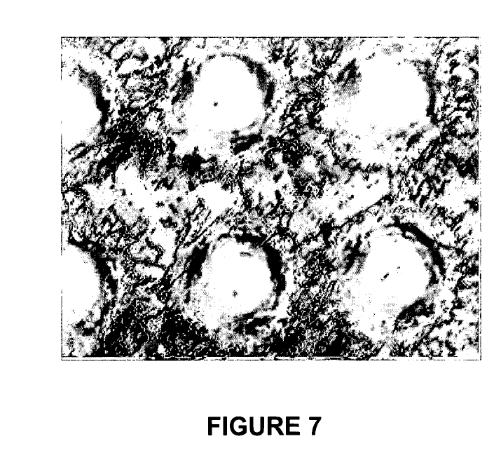

The laser marking system and method described above can be used the make laser marks (FIG. 5 illustrates a laser mark of depth d<1 μm, diameter Φ≈30 μm without splatter and burning, bottom flatness, profile clearness), a soft mark (FIG. 6 illustrates a soft mark of depth d≈3-5 μm, diameter Φ≈40 μm with slight splatter and burning, less profile clearness) or a hard mark (FIG. 7 illustrates a hard mark of depth d>5 μm, diameter Φ≈40 μm with splatter and burning, profile blur).

While the foregoing has been with reference to a particular embodiment of the invention, it will be appreciated by those skilled in the art that changes in this embodiment may be made without departing from the principles and spirit of the invention, the scope of which is defined by the appended claims.

1. A laser marker apparatus, comprising:
a laser light generation unit that generates laser light;
a laser power supply that supplies power to the laser light generation unit;
a beam expander that generates expanded laser light;
an adjustable polarizing device that adjusts an energy density of the expanded laser light; and
a galvanometric scanning element that receives the adjusted energy density expanded laser light and directs it towards a surface of a piece of material wherein the adjusted energy density expanded laser light is capable of generating a mark on the surface of the piece of material having low splatter.

2. The apparatus of claim 1, wherein the adjustable polarizing device further comprises a switching gear device that adjusts the energy density of the expanded laser light.

3. The apparatus of claim 1, wherein the adjustable polarizing device further comprises a diaphragm device and a polarizer angle device that adjust the diaphragm, aperture and polarizing angle of the expanded laser light to adjust the energy density of the expanded laser light.

4. The apparatus of claim 1, wherein the piece of material is a semiconductor wafer and wherein the mark is less than 1 micrometer in depth with minimal splatter.

5. The apparatus of claim 1, wherein the piece of material is a semiconductor wafer and wherein the mark has a depth of between 1 micrometer and 100 micrometers and is a light mark, a soft mark or a hard mark.

6. The apparatus of claim 1, wherein the laser light generation unit further comprises a neodymium-doped yttrium aluminum garnet laser.

7. The apparatus of claim 1, wherein the adjustable polarizing device adjusts the polarization angle of the expanded laser light between zero degrees and ninety degrees.

8. The apparatus of claim 7, wherein the adjustable polarizing device adjusts the polarization angle of the expanded laser light between sixty degrees and seventy degrees.

9. A method for laser marking of a piece of material using laser marking apparatus having a laser power supply, a laser transmitting system, a galvanometric scanning system and a computer control system, the method comprising:
adjusting an energy density of laser light using an adjustable polarizing device;
directing the adjusted energy density laser light towards a piece of material; and
generating a mark on a surface of the piece of material using the adjusted energy density laser light wherein the mark has an adjustable depth and a minimal amount of splatter.

10. The method of claim 9, wherein generating a mark on the piece of material further comprises generating a mark on a surface of a semiconductor substrate.

11. The method of claim 9, wherein adjusting the energy density of the laser light further comprising adjusting the polarization angle of the adjustable polarizing device between zero degrees and ninety degrees.

12. The method of claim 11, wherein adjusting the polarization angle further comprising adjusting the polarization angle of the laser light between sixty degrees and seventy degrees.
